(19) United States
(12) Patent Application Publication
(10) Pub. No.: US 2016/0311969 A1
(43) Pub. Date: Oct. 27, 2016

(54) THERMOPLASTIC POLYAMINOETHER

(71) Applicant: BLUE CUBE IP LLC, Midland, MI (US)

(72) Inventors: Lei YAN, Shanghai (CN); Wei ZHOU, Shanghai (CN); Yonghua Gong, Shanghai (CN); Hanbang Dong, Shanghai (CN)

(21) Appl. No.: 15/102,228

(22) PCT Filed: Dec. 9, 2013
(86) PCT No.: PCT/CN2013/088873

§ 371 Date: Jun. 6, 2016

(51) Int. Cl. C08G 59/50; C09J 163/00; B32B 37/14; B32B 27/08; B32B 27/20; B32B 27/28; C08L 95/00; B32B 11/04

(52) U.S. Cl. CPC C08G 59/5033; C08L 95/00; C09J 163/00; B32B 11/046; B32B 27/08; B32B 27/20; B32B 27/285; B32B 37/14; C08L 2207/04; C08G 2190/00; B32B 2307/54; B32B 2307/542

(57) ABSTRACT

A novel thermoplastic polyaminoether having good adhesion to asphalt and capable of being prepared at room temperature with short processing time; a multilayer including a layer of a thermoplastic polyaminoether capable of providing a wide operation window; and a thermoplastic asphalt composition including a thermoplastic polyaminoether with a high tensile strength.

### FIELD OF THE INVENTION

The present invention relates to a thermoplastic polyaminoether and a process for making the same; a multilayer article comprising a layer of the thermoplastic polyaminoether and a process for making the same; and a thermoplastic asphalt composition comprising the thermoplastic polyaminoether and a process for making the same.

### INTRODUCTION

Epoxy resins have a wide range of applications thanks to their satisfactory bonding and mechanical properties upon curing. For example, thermosetting epoxy resin compositions have been widely used as waterproofing and bonding layers between bridge decks and upper pavements in road and bridge infrastructure. During curing, once reaching a tack-free state, these epoxy resin compositions no longer provide sufficient adhesion to a newly applied substrate. Therefore, upper pavements such as hot mixed asphalt concrete are required to be paved before epoxy bonding layers reach the tack-free state to avoid delaminating and/or sliding between them, which limits the operation window of these thermosetting epoxy resin compositions.

In contrast, thermoplastic materials such as ethylene vinyl acetate (EVA) plastic membranes for use as waterproofing and bonding layers have limited processing advantages. For example, when hot mixed asphalt concrete is applied to the plastic membranes, the plastic membranes melt to bond the asphalt to bridge decks. However, the plastic membranes also have some disadvantages including for example, the membranes usually provide unacceptable chemical resistance and adhesion strength to the asphalt and bridge decks.

Another type of thermoplastic waterproofing and bonding layers known in the art is made from compositions comprising oleylamine and epoxy resins. Due to the slow reaction speed of oleylamine and epoxy resins, drying such compositions is usually too slow (for example, a tack-free time of greater than 10 hours) to be acceptable in the industry. Adding accelerators into such compositions can improve the drying speed, but the use of accelerators usually has the undesirable consequence of imparting brittleness to the resultant waterproofing and bonding layers.

### SUMMARY OF THE INVENTION

The present invention provides a novel thermoplastic material useful for preparing a waterproofing and bonding layer such as a layer between bridge decks and upper pavements in road and bridge infrastructure. The use of the novel thermoplastic material of the present invention shortens the processing time of such material and broadens the operation window of such material. In addition, the novel thermoplastic material has comparable or even better mechanical properties as compared to conventional thermoplastic resins such as thermoplastic resins made from oleylamine and epoxy resins; or as compared to conventional thermosetting epoxy systems.

The present invention includes: (1) a novel thermoplastic polyaminoether that can be prepared with a short processing time, as evidenced by a fast drying speed (for example, a tack-free time of less than about 7 hours) at room temperature (for example, 21-25° C.), and that has comparable or even better pull-off adhesion strength from asphalt relative to conventional thermoplastic resins such as thermoplastic resins made from oleylamine and epoxy resins; and a process for making the novel thermoplastic polyaminoether; (2) a multilayer article that can be used in a wider operation window and that maintains its shear strength relative to conventional thermosetting epoxy systems; and a process for making the multilayer article; and (3) a thermoplastic asphalt composition that has higher tensile strength than conventional thermoplastic resins such as thermoplastic resins made from oleylamine and epoxy resins.

In a first aspect, the present invention provides a novel thermoplastic polyaminoether having the structure of Formula (I):

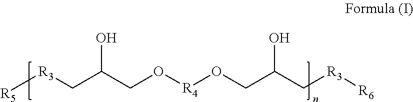

wherein each R₃ has the following structure:

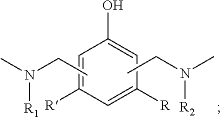

R₁ and R₂ each can be independently a monovalent group selected from an aliphatic, cycloaliphatic, aromatic, or polycyclic structure, or mixtures thereof; R can be a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅; R′ can be hydroxyl or hydrogen; R₄ can be a divalent aromatic moiety; R₅ and R₆ each can be independently

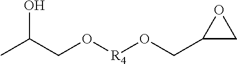

or hydrogen; and n can be an integer from about 1 to about 400.

In a second aspect, the present invention provides a process of preparing the novel thermoplastic polyaminoether of the first aspect. The process of preparing the thermoplastic polyaminoether of the first aspect includes for example the steps of:

(i) reacting the following components: (a) a monoprimary amine, (b) cashew nutshell liquid, and (c) an aldehyde to form a phenalkamine compound, wherein the molar ratio of the cashew nutshell liquid: aldehyde: monoprimary amine can be for example about 1.0:1.0-4.0:1.0-4.0; and

(ii) admixing the phenalkamine compound prepared in step (i) above with a diglycidyl ether, wherein the molar ratio of reactive hydrogens of the phenalkamine compound to oxirane groups of the diglycidyl ether can be for example from about 1:0.5 to about 1:2.

In a third aspect, the present invention provides a multilayer article comprising:

a first layer comprising a thermoplastic polyaminoether, wherein the thermoplastic polyaminoether is a reaction product of a phenalkamine compound having two reactive hydrogen functionalities and a diglycidyl ether, and wherein the molar ratio of reactive hydrogens of the phenalkamine compound to oxirane groups of the diglycidyl ether is from about 1:0.5 to about 1:2; and a second layer comprising asphalt.

In a fourth aspect, the present invention provides a process of preparing the multilayer article of the third aspect. The process of preparing the multilayer article of the third aspect includes for example the steps of:

(1) providing a phenalkamine compound having two reactive hydrogen functionalities;

(2) admixing the phenalkamine compound with a diglycidyl ether to form a reaction mixture, wherein the molar ratio of reactive hydrogens of the phenalkamine compound to oxirane groups of the diglycidyl ether is from about 1:0.5 to about 1:2;

(3) applying the reaction mixture to a substrate to form a first layer comprising a thermoplastic polyaminoether;

(4) separately heating asphalt; and

(5) applying the separately heated asphalt onto the first layer to form a second layer, such that the first layer resides between the substrate and the second layer.

In a fifth aspect, the present invention provides a thermoplastic asphalt composition comprising: asphalt; and a thermoplastic polyaminoether, wherein the thermoplastic polyaminoether is a reaction product of a phenalkamine compound having two reactive hydrogen functionalities and a diglycidyl ether, and wherein the molar ratio of reactive hydrogens of the phenalkamine compound to oxirane groups of the diglycidyl ether is from about 1:0.5 to about 1:2.

In a sixth aspect, the present invention provides a process for of preparing a thermoplastic asphalt composition of the fifth aspect. The process of preparing the thermoplastic asphalt composition of the fifth aspect includes for example the step of: admixing asphalt and a thermoplastic polyaminoether, wherein the thermoplastic polyaminoether is a reaction product of a phenalkamine compound having two reactive hydrogen functionalities and a diglycidyl ether, and wherein the molar ratio of reactive hydrogens of the phenalkamine compound to oxirane groups of the diglycidyl ether is from about 1:0.5 to about 1:2.

### DETAILED DESCRIPTION OF THE INVENTION

The novel thermoplastic polyaminoether of the present invention has the structure of Formula (I) (hereinafter referred to as “first thermoplastic polyaminoether”):

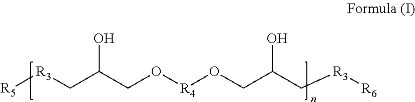

wherein R₃ has the following structure:

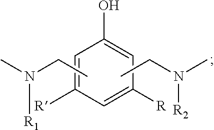

R₁ and R₂ each can be independently a monovalent group selected from an aliphatic, cycloaliphatic, aromatic or polycyclic structure, or mixtures thereof; R can be a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅; and R′ can be hydroxyl or hydrogen; R₄ can be a divalent aromatic moiety; R₅ and R₆ each can be independently

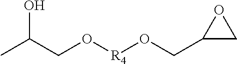

or hydrogen; and n can be an integer from about 1 to about 400, from about 2 to about 100 or from about 5 to about 10.

R₁ and R₂ in the above chemical structures each can be independently a monovalent group having from about 2 to about 22 carbon atoms. For example, R₁ and R₂ each can be independently a C₂-C₂₂ alkylene or substituted alkylene wherein the substituent(s) is arylcarbonyl, alkylcarbonyl, alkylamido, hydroxy, alkoxy, halo, cyano, aryloxy, or mixtures thereof; or a C₆-C₂₂ phenylene group; or mixtures thereof. The term “Cₓ” refers to a molecular fragment having x number of carbon atoms where x is a numeric value.

R₁ and R₂ each can also be, for example, independently a monovalent group selected

from a cycloaliphatic structure such as

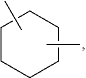

an aromatic structure such as

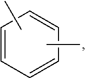

or a polycyclic structure such as

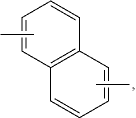

or mixtures thereof.

In some preferred embodiments, R₁ and R₂ each is independently a C₂-C₂₂ hydroxyalkyl group. In a preferred embodiment, both R₁ and R₂ are hydroxyethylene.

R₄ in the above chemical structures may have from about 2 to about 50 carbon atoms. R₄ can be a divalent moiety selected from isopropylidenediphenylene, phenylene, biphenylene, butadiene, hexadiene, ethylene, cyclohexane dimethylene, or combinations thereof. In a preferred embodiment, R₄ has the following structure:

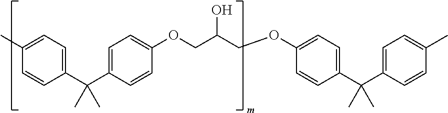

wherein m can be an integer from 0 to about 5 or an integer from about 1 to about 4.

In some embodiments, the first thermoplastic polyaminoether of the present invention has a viscosity at 120° C. of from about 0.1 pascal·second (Pa·s) to about 400 Pa·s, from about 1 Pa·s to about 300 Pa·s, or from about 10 Pa·s to about 200 Pa·s, according to the test method described in the Examples section below.

The first thermoplastic polyaminoether of the present invention can be prepared from a reaction mixture comprising a phenalkamine compound and a diglycidyl ether, wherein the molar ratio of reactive hydrogens of the phenalkamine compound to oxirane groups of the diglycidyl ether is from about 1:0.5 to about 1:2. The phenalkamine compound used to prepare the first thermoplastic polyaminoether may be obtained by reacting (a) a monoprimary amine, (b) cashew nutshell liquid (“CNSL”), and (c) an aldehyde at the molar ratio of CNSL:aldehyde:monoprimary amine of about 1.0:1.0-4.0:1.0-4.0.

The phenalkamine compound used to prepare the first thermoplastic polyaminoether of the present invention may comprise a compound having the following structure:

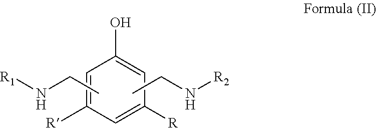

wherein R₁, R₂, R, and R′ are as previously defined with reference to Formula (I).

The monoprimary amine used to prepare the phenalkamine compound refers to an amine compound having only one primary amine group and containing no secondary or tertiary amine group. The monoprimary amine may be an amine having two active hydrogen atoms that comprises a C₂-C₂₂ carbon atoms aliphatic hydrocarbon group or an alkyl phenol group in which the alkyl group has 2 to 22 carbon atoms. The monoprimary amines may be alkyl amines and substituted alkyl amines, alkanol amines, or mixtures thereof. Examples of suitable monoprimary amines include monoethanolamine (“2-aminoethanol”); oleylamine; aniline and substituted anilines such as 4-(methylamido)aniline, 4-methoxyaniline, 4-tertbutylaniline, 3,4-dimethoxyaniline, and 3,4-dimethylaniline; octyl amine; 1-tetradecylamine; 1-butanamine; cyclohexylamine; benzylamine; dodecanamine; lauryl amine; myristyl amine, palmityl amine; stearyl amine; behenyl amine; beef tallow amine; butylamine; 1-aminopropan-2-ol; or mixtures thereof. In some embodiments, monoethanolamine (MEA) is used in the present invention.

The CNSL used to prepare the phenalkamine compound may comprise cardanol. Cardanol herein refers to a mixture of phenols which contain one hydroxyl group and differ in the number of C═C bonds in the aliphatic side chain in the meta-position. The structure of cardanol is shown as the following Formula (III):

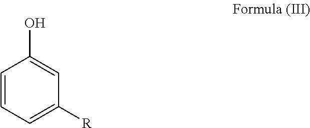

wherein R is as previously defined with reference to Formula (I). The cardanol may be a mixture that variously comprises cardanols having different R groups.

The concentration of cardanol in the CNSL may be, based on the total weight of the CNSL, about 10 weight percent (wt %) or more, about 50 wt % or more, or even about 90 wt % or more, and at the same time, about 99 wt % or less, about 97 wt % or less, or even about 95 wt % or less.

The CNSL used to prepare the phenalkamine compound may also comprise cardol. Cardol has the following Formula (IV):

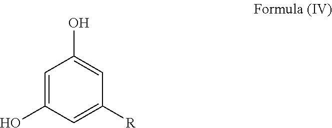

wherein R is as previously defined with reference to Formula (I).

The concentration of cardol in the CNSL may be, based on the total weight of the CNSL, about 0.1 wt % or more, about 1 wt % or more, or even about 5 wt % or more, and at the same time, about 90 wt % or less, about 50 wt % or less, or even about 10 wt % or less.

The CNSL may also comprise anacardic acid, oligomers of cardanol, oligomers of cardol, and mixtures thereof.

The CNSL used to prepare the phenalkamine compound may be produced from natural CNSL through a heating process (for example, at the time of extraction from cashew nuts), a decarboxylation process, and/or a distillation process. Examples of suitable commercially available CNSL include technical cashew nutshell liquid available from Huada Saigao (Yantai) Science & Technology Company Limited.

The aldehyde used to prepare the phenalkamine compound can be formaldehyde, acetaldehyde, propionaldehyde, n-butyraldehyde, n-valeraldehyde, caproadlehyde, heptaldehyde, phenylacetaldehyde, benzaldehyde, o-tolualdehyde, tolualdehyde, p-tolualdehyde, furfural, salicylaldehyde (o-hydro-xybenzaldehyde), p-hydroxybenzaldehyde, anisaldehyde, formalin solution, paraformaldehyde, formaldehyde, any substituted aldehyde, or mixtures thereof. In a preferred embodiment, formaldehyde or paraformaldehyde is used in the present invention.

The phenalkamine compound used to prepare the first thermoplastic polyaminoether of the present invention can be prepared according to Mannich reaction conditions known in the art. The phenalkamine compound may be prepared by providing the aldehyde, the monoprimary amine and the CNSL described above, and reacting them via the Mannich reaction to form the phenalkamine compound. Solvents such as benzene, toluene or xylene can be used for removal of water produced during this reaction at an azeotropic distillation point. Nitrogen is also recommended for use to ease the water removal. The reaction may be conducted at a temperature from about 60° C. to about 130° C., or from about 80° C. to about 110° C. The initial molar ratio of CNSL:aldehyde:monoprimary amine for preparing the phenalkamine compound can vary in the range of about 1.0:1.0-4.0:1.0-4.0, in the range of about 1.0:1.0-3.0:1.0-3.0, or in the range of about 1.0:2.0-2.5:2.0-2.5. In some embodiments, the CNSL and the monoprimary amine are mixed, and then the aldehyde is added into the resulting mixture. Time duration for adding the aldehyde can vary in the range of from about 0.5 hour to about 2 hours or in the range of from about 0.6 hour to about 1 hour. The resultant mixture may be post-treated by distillation under reduced pressure to remove residue volatiles.

In preparing the first thermoplastic polyaminoether of the present invention, the phenalkamine compound described above is further mixed with one or more diglycidyl ethers, wherein the molar ratio of reactive hydrogens of the phenalkamine compound to oxirane groups of the diglycidyl ether is from about 1:0.5 to about 1:2, from about 1:0.9 to about 1:1.1, or from about 1:0.95 to about 1:1.05, and preferably about 1:1.

The diglycidyl ether useful in the present invention can be solid or liquid. The diglycidyl ether may be based on reaction products of epichlorohydrin with polyfunctional alcohols, phenols, cycloaliphatic carboxylic acids, aromatic amines, aminophenols, or mixtures thereof. Examples of suitable diglycidyl ethers include bisphenol A diglycidyl ether, bisphenol F diglycidyl ether, resorcinol diglycidyl ether, butane-1,4-diol diglycidyl ether, hexane-1,6-diol diglycidyl ether, ethylene glycol diglycidyl ether, cyclohexanedimethanol diglycidyl ether, or mixtures thereof. In a preferred embodiment, bisphenol A diglycidyl ether is used in the present invention. Suitable commercially available diglycidyl ethers may include, for example, D.E.R.™ 331 and D.E.R. 383 epoxy resins both available from The Dow Chemical Company (D.E.R. is a trademark of The Dow Chemical Company).

In preparing the first thermoplastic polyaminoether of the present invention, the reaction of the reaction mixture comprising the phenalkamine compound and the diglycidyl ether may be conducted under conditions sufficient to cause the amine moieties to react with epoxy moieties to form a polymer backbone having amine linkages, ether linkages, and pendant hydroxyl moieties. For example, the temperature of the reaction may range from about −20° C. to about 120° C., from about 5° C. to about 50° C., or from about 20° C. to about 30° C. The time for the reaction may be from about 30 seconds to about 28 days or from about 1 minute to about 7 days. In some embodiments, the reaction mixture comprising the phenalkamine compound and the diglycidyl ether shows shorter tack-free time than formulations wherein the phenalkamine compound is replaced by oleylamine. For example, the tack-free time of the reaction mixture may be about 7 hours or less, about 5 hours or less, about 4 hours or less, or even about 3 hours or less, according to the test method described in the Examples section. Thus, the first thermoplastic polyaminoether of the present invention can be prepared with a shorter processing time compared to conventional thermoplastic resins made from oleylamine and epoxy resins which have a tack-free time of 10 hours or longer. Therefore, the use of the first thermoplastic polyaminoether of the present invention for paving roads allows for a paved road to open to traffic within a short period of time such as less than about 7 hours. The reaction may be conducted in the absence of or in the presence of one or more catalysts to speed up the reaction. Examples of suitable catalysts for the reaction include tris(dimethylaminomethyl)-phenol, bis(dimethylaminomethyl)-phenol, salicylic acid and bisphenol A. When present in the reaction mixture, the amount of the catalyst used may be from 0.1 wt % to 20 wt % or from 1 wt % to 5 wt %, based on the weight of the reaction mixture.

The primary two starting materials, described above to produce the first thermoplastic polyaminoether of the present invention, can be supplied as two separate components for use in conventional equipment commonly used for processing a two-component system (the two components referred to herein as “Part A” and “Part B”). During application, Part A comprising the phenalkamine compound and Part B comprising the diglycidyl ether may be stored in two different tanks. Then when ready for use, Part A and Part B can be mixed on-site to form the reaction mixture. Then the reaction mixture can be applied to a substrate such as a steel plate, cement concrete, or asphalt concrete.

In another embodiment, the first thermoplastic polyaminoether may be supplied in one-pack system for example wherein the thermoplastic polyaminoether is in the form of (1) solid flakes or (2) a solution in a solvent.

The present invention also relates to a multilayer article which includes a combination of at least two or more layers. In one embodiment for example, the multilayer article of the present invention may comprises a first and second layer. The first layer may comprise a thermoplastic polyaminoether, and the second layer may comprise an asphalt layer. In one embodiment, the thermoplastic polyaminoether first layer of the multilayer article can be any thermoplastic polyaminoether which includes a reaction product of a phenalkamine compound having two reactive hydrogen functionalities and a diglycidyl ether, wherein the molar ratio of reactive hydrogens of the phenalkamine compound to oxirane groups of the diglycidyl ether may be from about 1:0.5 to about 1:2.

For example, in some embodiments, the thermoplastic polyaminoether used to make the first layer in the multilayer article can be one or more first thermoplastic polyaminoethers of Formula (I) described above. In these embodiments, the phenalkamine compound having two reactive hydrogen functionalities is a Mannich reaction product of (a) the monoprimary amine described above, (b) the CNSL described above, and (c) the aldehyde described above, wherein the molar ratio of CNSL: aldehyde: monoprimary amine may be in the range of about 1.0:1.0-4.0:1.0-4.0, in the range of about 1.0:1.0-3.0: 1.0-3.0, or in the range of about 1.0:2.0-2.5:2.0-2.5.

In some other embodiments, the thermoplastic polyaminoether used to make the first layer in the multilayer article can also be, for example, one or more second thermoplastic polyaminoethers prepared from a polyamine having only one primary amine group and only one secondary amine group. In these embodiments, the phenalkamine compound having two reactive hydrogen functionalities is a Mannich reaction product of (a) the polyamine, (b) the CNSL described above, and (c) the aldehyde described above, wherein the molar ratio of CNSL:aldehyde:polyamine may be in the range of about 1.0:0.8-1.8:0.8-1.8, or in the range of about 1.0:1-1.5:1-1.5. Examples of suitable polyamines include N-aminoethylpiperazine (AEP), 1H-imidazole-2-carboxamide, N-methylethylenediamine, N-methyl-1,3-propanediamine, N-coco propylene diamine, or mixtures thereof. In a preferred embodiment, AEP is used as the polyamine component in the present invention. In some other embodiments, a mixture of the first and second thermoplastic polyaminoethers may also be used as the thermoplastic polyaminoether to make the first layer in the multilayer article.

The first layer of the multilayer article of the present invention may also comprise one or more diluents. Examples of suitable diluents include the CNSL described above; nonyl phenol; benzyl alcohol; furfuryl alcohol; monoglycidyl compounds such as monoglycidyl ethers, allyl monoglycidyl ethers, phenol monoglycidyl ethers, monoglycidyl esters, C₁₂-C₁₄ alkyl monoglycidyl ethers, or mixtures thereof; diglycidyl compounds such as polyethylene glycol diglycidyl ethers, polypropylene diglycidyl ethers, ethylene oxide-propylene oxide copolymer diglycidyl ethers, neopentyl glycol diglycidyl ethers, 1,4-butanediol diglycidyl ether, 1,6-hexanediol diglycidyl ether, cyclohexanedimethanol diglycidyl ether, bisphenol-A alkoxylate diglycidyl ethers, or mixtures thereof; bisphenol-A alkoxylates; or mixtures thereof. In a preferred embodiment, the first layer useful in the present invention comprises the CNSL. The diluent may be present, based on the weight of the first layer, in an amount of 0 wt % or more, or even about 1 wt % or more, and at the same time, about 40 wt % or less, about 30 wt % or less, about 20 wt % or less, or even about 10 wt % or less. The first layer of the multilayer article of the present invention may further comprise one or more catalysts. Catalysts may be any catalysts that can speed up the reaction between the diglycidyl ether and the phenalkamine compound having two reactive hydrogen functionalities. Examples of suitable catalysts include tris(dimethylaminomethyl)-phenol, bis(dimethylaminomethyl)-phenol, salicylic acid and bisphenol A, or mixtures thereof. When present, the concentration of the catalyst may be, based on the weight of the first layer, from about 0.01 wt % to about 20 wt %, from about 0.1 wt % to about 10 wt %, or from about 1 wt % to about 5 wt %.

The first layer of the multilayer article of the present invention may further comprise aggregates. Aggregates are usually used for many applications such as micro-surfacing or slurry seal. Aggregates herein refer to a broad category of coarse particulate material used in construction, including for example sand, gravel, crushed stone, slag, recycled concrete, geosynthetic aggregates, or mixtures thereof. Aggregates may be selected from dense-graded aggregates, gap-graded aggregates, open-graded aggregates, reclaimed asphalt pavement, or combinations thereof. The aggregates may be present in an amount of from about 0 wt % to about 99 wt %, from about 10 wt % to about 80 wt %, or from about 20 wt % to about 50 wt %, based on the weight of the first layer.

The first layer of the multilayer article of the present invention may further comprise fillers. Fillers can be selected from titanium dioxide, barytes, talc, calcytes, clay, kaolin, carbon black, crystalline quartz, magnetite, silicates, aluminum silicates, calcium sulfates, calcium carbonate, barium salts, or mixtures thereof. The fillers may be present in an amount of from 0 wt % to about 80 wt %, from about 10 wt % to about 70 wt %, or from about 20 wt % to about 60 wt %, based on the weight of the first layer.

The first layer of the multilayer article of the present invention may also comprise one or more of the following additives: pigments, leveling assistants, flow modifiers, thixotropic agents, adhesion promoters, stabilizers, plasticizers, catalyst de-activators, styrene copolymers such as styrene-butadiene rubber (SBR) or styrene-butadiene-styrene (SBS) copolymers, flame retardants, anti-rutting agents, and anti-stripping agents. These additives may be present in a combined amount of from 0 wt % to about 10 wt % or from about 1 wt % to about 5 wt %, based on the weight of first layer.

Generally, the first layer of the multilayer article of the present invention may have any desired thickness depending on the application of the article. For example, the thickness of the first layer may be from about 0.5 millimeter (mm) to about 15 mm in one embodiment, from about 0.8 mm to about 10 mm in another embodiment, and from about 1 mm to about 5 mm in another embodiment.

The second layer of the multilayer article of the present invention comprises asphalt. The asphalt useful in the present invention may be any asphalt known in the art, or mixtures of different types of asphalt. Examples of suitable asphalt include heavy traffic asphalt such as AH-70 or AH-90 asphalt, polymer-modified asphalt such as SBS- or SBR-modified asphalt, or mixtures thereof. The asphalt useful in the present invention may have a needle penetration at 25° C. of from 40 decimillimeters (dmm) to about 100 dmm, from about 50 dmm to about 90 dmm, or from about 60 dmm to about 90 dmm according to the 70604-2011 method described in the JTG E20-2011 standard. Suitable commercially available asphalt useful in the present invention may include, for example, Zhonghai 70^{#} asphalt, Zhonghai 90^{#} asphalt, Donghai 70^{#} asphalt, and Donghai 90^{#} asphalt all available from Sinopec; AH-70^{#} asphalt and AH-90^{#} asphalt both available from Shell; or mixtures thereof. Generally, the second layer of the multilayer article may have any desired thickness depending on the application of the article. For example, the thickness of the second layer may be from about 20 mm to about 150 mm in one embodiment, from about 30 mm to about 100 mm in another embodiment, and from about 40 mm to about 60 mm in another embodiment.

The process of preparing the multilayer article of the present invention comprises: (1) providing the phenalkamine compound having two reactive hydrogen functionalities, (2) admixing the phenalkamine compound having two reactive hydrogen functionalities with the diglycidyl ether to form a reaction mixture, wherein the molar ratio of reactive hydrogens of the phenalkamine compound to oxirane groups of the diglycidyl ether is from about 1:0.5 to about 1:2; (3) applying the reaction mixture to at least a portion of the surface of a substrate to form a first layer on at least a portion of the substrate comprising a thermoplastic polyaminoether; (4) separately heating asphalt; and (5) applying the separately heated asphalt onto at least a portion of the first layer to form a second layer on at least a portion of the first layer, such that the first layer resides between the substrate and the second layer.

In step (1) of preparing the multilayer article of the present invention, the phenalkamine compound having two reactive hydrogen functionalities can be prepared by the Mannich reaction of the CNSL, the aldehyde, and the monoprimary amine or the polyamine described above. Conditions of the Mannich reaction are substantially the same as the preparation of the phenalkamine compound used to prepare the first thermoplastic polyaminoether of Formula (I) described above. When the monoprimary amine is used, the molar ratio of CNSL: formaldehyde: monoprimary amine may be in the range of about 1.0:1.0-4.0:1.0-4.0, in the range of about 1.0:1.0-3.0:1.0-3.0, or in the range of about 1.0:2.0-2.5:2.0-2.5. When the polyamine is used, the molar ratio of CNSL:aldehyde:polyamine may be in the range of about 1.0:0.8-1.8:0.8-1.8, in the range of about 1.0:1-1.5:1-1.5, or in the range of about 1.0:1-1.1:1-1.1.

In step (2) of preparing the multilayer article of the present invention, the reaction conditions, and preferred molar ratios of reactive hydrogens of the phenalkamine compound to oxirane groups of the diglycidyl ether are the same as in preparing the first thermoplastic polyaminoether of Formula (I) described above.

In step (3) of preparing the multilayer article of the present invention, the substrate may be steel, cement concrete, or asphalt concrete.

In step (4) of preparing the multilayer article of the present invention, the asphalt can be heated to about 120° C. or higher, or even about 140° C. or higher.

In preparing the multilayer article of the present invention, the time gap between applying the reaction mixture comprising the phenalkamine compound having two reactive hydrogen functionalities and the diglycidyl ether (step (3)) and applying the asphalt (step (5)) can be as short as about 12 hours or less, or even as short as about 0.5 hours or less. The time gap can also be as long as about 2 days or more, or even as long as about 5 days or more. Thus, the present invention allows a wide operation window. Compared to conventional thermosetting epoxy formulations, mechanical properties of the multilayer article of the present invention is much less sensitive to the time gap. For example, when the time gap changes from about 2 hours to about 1 day, the pull-off adhesion strength of the resultant multilayer articles decreases no more than about 50%, or even no more than about 20%. The multilayer article of the present invention has a much wider operation window compared to conventional thermosetting epoxy formulations.

The present invention also relates to a thermoplastic asphalt composition (TAC). The TAC of the present invention comprises at least two components including (i) asphalt, and (ii) a thermoplastic polyaminoether, wherein the thermoplastic polyaminoether is a reaction product of a phenalkamine compound having two reactive hydrogen functionalities, and a diglycidyl ether, wherein the molar ratio of reactive hydrogens of the phenalkamine compound to oxirane groups of the diglycidyl ether is from about 1:0.5 to about 1:2, or from about 1:0.9 to about 1:1.1. The thermoplastic polyaminoether component present in the TAC may be substantially the same as the thermoplastic polyaminoether described above with reference to the multilayer article.

The asphalt component present in the TAC of the present invention is substantially the same as the asphalt described above with reference to the multilayer article. The concentration of the asphalt in the thermoplastic polyaminoether may be, based on the total weight of the TAC, about 1 wt % or higher, about 10 wt % or higher, or even about 20 wt % or higher, and at the same time, about 99 wt % or lower, about 97 wt % or lower, or even about 95 wt % or lower.

The phenalkamine compound having two reactive hydrogen functionalities used to prepare the TAC of the present invention is the same as that described above with reference to the multilayer article.

The TAC of the present invention may further comprise one or more catalysts. The catalysts may be used to speed up the reaction between the diglycidyl ether and the phenalkamine compound having two reactive hydrogen functionalities. The catalysts can be substantially the same as those described above with reference to the first layer of the multilayer article. When present, the concentration of the catalyst may range, based on the total weight of the TAC, from about 0.01 wt % to about 20 wt %, from about 0.1 wt % to about 10 wt %, or from about 1 wt % to about 5 wt %.

The TAC of the present invention may further comprise one or more diluents or solvents. Examples of suitable solvents include an alcohol such as ethanol, isopropanol, iso- or a normal-butanol, or mixtures thereof; an aromatic hydrocarbon such as benzene, toluene, xylene, or mixtures thereof; a ketone such as methyl isobutyl ketone, methyl ethyl ketone, cyclohexanone, or mixtures thereof; an ether such as methyl tertiary butyl ether, propylene glycol monomethyl ether, tetrahydrofuran, 1,2-dimethoxyethane, 1,2-diethoxy ethane, ethylene glycol monobutyl ether, or mixtures thereof; an ester such as ethyl acetate, butyl acetate, or mixtures thereof; oil of turpentine; a terpene-hydrocarbon oil such as D-limonene, pinene, or mixtures thereof; a high boiling point paraffin type solvent such as a mineral spirit, SOLVESSO™ 100 solvent available from Exxon-Chemical Corporation Co., Ltd., or mixtures thereof. The diluents in the TAC may include those diluents in the multilayer article described above. The combined concentration of the diluents and solvents in the TAC may be, based on the total weight of the TAC, 0 wt % or more, about 1 wt % or more, or even about 2 wt % or more, and at the same time, about 40 wt % or less, about 30 wt % or less, about 20 wt % or less, or even about 10 wt % or less.

In addition to the components described above, the TAC of the present invention may further comprise one or more of the additives described above in the first layer of the multilayer article. When present, these additives may be present in a combined amount of from about 0.001 wt % to about 10 wt % or from about 0.01 wt % to about 2 wt %, based on the total weight of the TAC.

The TAC of the present invention may be prepared by mixing the thermoplastic polyaminoether with the diglycidyl ether to form a reaction mixture, separately heating asphalt, and mixing the reaction mixture with the separately heated asphalt. Other optional components in the TAC may be added into the reaction mixture prior to or after mixing with the asphalt.

The TAC of the present invention provides higher tensile strength at room temperature than conventional formulations comprising asphalt, epoxy resins, and oleylamine. The TAC of the present invention may be used as water-proofing and/or bonding materials in various applications. In particular, the TAC is suitable for use in road paving and maintenance applications such as tack coats, fog seals, slurry seals, and micro-surfacing.

### EXAMPLES

Some embodiments of the present invention will now be described in the following Examples, wherein all parts and percentages are by weight unless otherwise specified.

D.E.R. 383 resin, available from The Dow Chemical Company, is a diglycidyl ether of bisphenol A and has an epoxy equivalent weight (“EEW”) of from 176 to 183.

D.E.R. 331 resin, available from The Dow Chemical Company, is a diglycidyl ether of bisphenol A and has an EEW of from 182 to 192.

Technical cashew nutshell liquid (“CNSL”), available from Huada Saigao (Yantai) Technology Company Ltd., comprises about 66 wt % of cardanol, about 14 wt % of cardol, and about 20 wt % of polymerized materials, based on the total weight of the technical CNSL.

MARK 135, available from The Dow Chemical Company, includes Part A comprising a bisphenol A epoxy resin and reactive diluents; and Part B comprising an aliphatic amine and diluents.

Oleylamine is used as a curing agent and is available from Rhodia China.

Aminoethylpiperazine (“AEP”) and monoethanoamine (“MEA”) are both available from Sinopharm Chemical Reagent Co., Ltd.

Asphalt 70^{#} is available from Royal Dutch Shell China.

### Viscosity Measurement

Viscosity of a thermoplastic resin or a hardener is measured using ARES G2 viscometer of TA Instruments equipped with an environmental chamber. Samples are filled into the gap (from 0 5 mm to 2 mm) between two 25 mm parallel stainless plates and are tested at a shear rate of 100 reciprocal second (1/s). The temperature of the environmental chamber is set up at 120° C. when evaluating the thermoplastic resin, or 25° C. when evaluating the hardener, respectively.

### Pull-Off Adhesion Test

Ingredients of an epoxy resin composition comprising epoxy resin(s) and an amine compound are mixed and casted on a cement concrete board to form a first layer with a thickness of around 1 mm After one day at room temperature, separately heated asphalt (160° C.) is applied to the first layer. Then, six dollies are placed onto the surface of the asphalt. After another day at room temperature, a pull-off tester is employed to measure the pull-off adhesion strength between the asphalt and the first layer by pulling the drawing head at a pulling rate of 150 newtons per second (N/s) at room temperature.

### Shear Strength Test

Ingredients of an epoxy resin composition are mixed and applied to the surface of a cement concrete with a size of about 40 centimeters (cm) x 40 cm. After 2 hours at room temperature, or 1 day at room temperature, respectively, stone mastic asphalt concrete is paved on top of the layer of the epoxy resin composition to form sandwich structured test samples with 2-hour time gap, or 1-day time gap, respectively. The layer of the epoxy resin composition serves as a waterproofing and adhesion layer between the cement concrete and the asphalt concrete. After another day of reaction at room temperature, the sandwiched sample is cut into a size of 10 cm×10 cm, and then is tested at a shear rate of 50 millimeters per minute (mm/min) with an angle of 30° at room temperature. The shear strength of the samples is determined at the failure point of the samples. The shear strength of the sample with 2-hour time gap (the asphalt concrete is applied 2 hours after the application of the epoxy resin composition) is denoted as “Shear Strength (2-hour time gap)”. The shear strength of the sample with 1-hour time gap (the asphalt concrete is applied 1 day after the application of the epoxy composition) is denoted as “Shear Strength (1-day time gap)”.

### Drying Time

The drying time of an epoxy resin composition is conducted at room temperature according to the ASTM D5895 method “Standard Test Methods for Evaluating Drying or Curing During Film Formation of Organic Coatings Using Mechanical Recorders”. Ingredients of the epoxy resin composition are mixed and casted on glass panels to form a layer with a thickness of 300 μm at room temperature. The drying time is then measured on a Beck Koller drying time recorder.

### Tensile Strength

The tensile strength of a thermoplastic asphalt composition is measured according to the ASTM D 638-10 method “Standard Test Method for Tensile Properties of Plastics” on an Instron machine at a test speed of 5 mm/min and a gauge length of 50 mm The thermoplastic asphalt composition to be evaluated is casted into a dog bone shape mold and allowed to react for 7 days at room temperature.

### Synthesis of Phenalkamine Compound-I

Phenalkamine Compound-I was prepared as follows. 296.9 grams (g) (1.0 mole) of technical CNSL and 122.2 g (2.0 moles) of MEA were mixed in a 1 liter round flask equipped with a Dean-Stark water trap connected to a refluxing condenser, a mechanical stirrer and a nitrogen adapter. The mixture was heated to 80° C. With continuous mechanical stirring, nitrogen flow and water circulation, 70.3 g of paraformaldehyde (2.2 moles, 94%) was charged into the flask over a time period of 1 hour. The flask temperature was then raised to 110° C. and 63.7 g of xylene was charged to initiate a water separation under 0.3 L/min nitrogen flow. When the technical CNSL was consumed, as determined by observing TLC under 254 nm ultraviolet, the reaction was stopped. The resultant mixture was further treated by distillation under reduced pressure (90° C., 100 mbar vacuums) to remove the residue of xylene and water. The obtained product had an amine value of 218 milligram potassium hydroxide per gram sample (mg KOH/g) (ISO 9702), a viscosity of 36 Pa·s at 25° C., and a molecular mass of 464.4 [M+18]⁺ according to Liquid Chromatography-Mass Spectrometer (LC-MS) performed on an Agilent 1220.

### Synthesis of Phenalkamine Compound-II

Phenalkamine Compound-II was prepared as follows. A 1-litre round flask was equipped with a Dean-Stark water trap connected to a refluxing condenser, a mechanical stirrer and a nitrogen adapter. 296.9 g (1 mole) of technical CNSL and 180.6 g (1.1 moles) of AEP were mixed in the flask and stirred to be homogeneous; and then the homogeneous mixture was heated to 80° C. With continuous mechanical stirring, mild nitrogen flow and cooling water circulation, 46.3 g (1.15 moles) of paraformaldehyde were charged into the flask. Then, 31.9 g (0.3 mole) of xylene were added to the flask and the flask temperature was raised to 110° C. Water generated during reaction was removed by xylene under azeotropic distillation. When the technical CNSL was consumed, as determined by observing TLC under 254 nm ultraviolet, the reaction was stopped. The obtained mixture was further treated distillation under reduced pressure (90° C., 100 mbar vacuums) to remove the residue of xylene and water. The resultant product appeared black and viscous; and had a viscosity of around 1.082 Pa·s at 25° C., an amine value of 391 mgKOH/g (ISO 9702), and a molecular mass of 444.4 [M+18]⁺ according to LC-MS performed on an Agilent 1220.

### Examples (Exs) 1-3 and Comparative Examples (Comp Exs) A-C

Epoxy resin compositions of Exs 1-3 and Comp Exs A-C were prepared by mixing ingredients described in Table 1. Properties of the epoxy resin compositions and the resultant reaction products were evaluated according to the test method described above; and the results of the evaluations are reported in Table 2.

TABLE 1

| | Epoxy Resin Compositions, weight part | | | | | |
|---|---|---|---|---|---|---|
| | Comp | Comp | Comp | | | |
| Components | Ex A | Ex B | Ex C | Ex 1 | Ex 2 | Ex 3 |
| D.E.R. 383 epoxy | 52.7 | | | | | |
| resin | | | | | | |
| D.E.R. 331 epoxy | | 59.4 | | 45.9 | 46.1 | 41.4 |
| resin | | | | | | |
| DETA | 6.1 | | | | | |
| MARK 135 Part A | | | 69 | | | |
| MARK 135 Part B | | | 31 | | | |
| Phenalkamine | | | | 54.1 | | 48.6 |
| Compound-I | | | | | | |
| Phenalkamine | | | | | 53.9 | |
| Compound-II | | | | | | |
| Technical CNSL | 41.2 | | | | | 10 |
| Oleylamine | | 40.6 | | | | |

As shown in Table 2, the epoxy resin compositions of Exs 1-2 show a much shorter drying time (a tack-free time of around 2.6 hours) than the epoxy compositions of Comp Exs A-B (a tack-free time of 10 hours or longer). The sample of Comp Ex B was still soft one day after mixing the ingredients of Comp Ex B. The results in Table 2 indicate that the reactivity of Phenalkamine Compound-I or II with epoxy resins is higher than that of oleylamine, allowing for a shorter open time (the time period between applying the epoxy composition to a substrate until the substrate can be open to traffic).

As shown in Table 2, the reaction products made from the epoxy resin compositions of Exs 1-3 have a viscosity at 120° C. of 137 Pa·s, 48 Pa·s, and 130 Pa·s, respectively, which indicates that the reaction products of the present invention are thermoplastic.

As shown in Table 2, the pull-off adhesion strength of Exs 1-2 is 2.04 megapascals (MPa) and 2.35 MPa, respectively, which are comparable to or better than that of the conventional thermoplastic system of Comp Ex B. In contrast, the pull-off adhesion strength of Comp Ex A is only 1.11 MPa. The results in Table 2 indicate that the obtained thermoplastic resin of the present invention provides better adhesion to the asphalt compared to the thermosetting system of Comp Ex A.

TABLE 2

| | | | | |
|---|---|---|---|---|
| Comp | Comp | | | |
| Ex A | Ex B | Ex 1 | Ex 2 | Ex 3 |

Properties of epoxy resin compositions

| | | | | | |
|---|---|---|---|---|---|
| Tack-free time of epoxy resin | 10 | 16 | 2.6 | 2.6 | — |
| composition, hour | | | | | |

Properties of reaction products

| | | | | | |
|---|---|---|---|---|---|
| Viscosity of reaction product | — | 43 | 137 | 48 | 130 |
| at 120° C., Pa · s | | | | | |
| Pull-off adhesion strength, | 1.11 | 2.00 | 2.04 | 2.35 | — |
| MPa | | | | | |

Table 3 shows properties of the reaction products made from the epoxy resin compositions of Ex 3, and Comp Exs A and C. When the time gap between the application of the epoxy composition and the asphalt concrete increased from 2 hours to 1 day, the shear strength of Ex 3 only decreased from 6.4 MPa to 5.9 MPa (about 8% decrease) and failure occurred in either the asphalt concrete or the cement concrete. The shear strength of Comp Ex A, on the other hand, decreased from 6.7 MPa to 2.7 MPa (nearly 60% decrease) and failure occurred on the adhesion interface. The shear strength of the sample of Comp Ex C was too small to measure (<0.5 MPa) when the upper asphalt concrete was applied 1 day after the application of the epoxy composition of Comp Ex C. The results in Table 3 indicate that thermoplastic reaction products of the present invention is much less sensitive to the time gap between the application of the epoxy resin composition and the upper asphalt concrete, indicating a wider operation window.

TABLE 3

| | Properties of reaction products | | |
|---|---|---|---|
| | Comp | | |
| | Ex A | Comp Ex C | Ex 3 |
| Shear Strength (2-hour time gap), MPa | 6.7 | 5.2 | 6.4 |
| Shear Strength (1-day time gap), MPa | 2.7 | <0.5 | 5.9 |
| Decrease of shear strength when the time | 60% | >90% | 8% |
| gap increased from 2 hours to 1 day | | | |

### Ex 4 and Comp Ex D

Thermoplastic asphalt compositions of Ex 4 and Comp Ex D were prepared based on formulations described in Table 4. D.E.R. 331 epoxy resin and an amine compound (Phenalkamine Compound I or oleylamine) were mixed at room temperature, then added into asphalt which was already separately heated to 160° C. to form thermoplastic asphalt compositions of Ex 4 and Comp Ex D, respectively. The tensile strength of the obtained thermoplastic asphalt composition was then evaluated according to the test method described above; and the results are reported in Table 4. As shown in Table 4, the thermoplastic asphalt composition of Ex 4 provides a tensile strength of 2.0 MPa which is much higher than that of Comp Ex D (0.11 MPa).

TABLE 4

| | |
|---|---|
| Ex 4 | Comp Ex D |

Component, weight part

| | | |
|---|---|---|
| D.E.R. 331 epoxy resin | 45.9 | 59.4 |
| Phenalkamine Compound-I | 54.1 | — |
| Oleylamine | — | 40.6 |
| Asphalt 70^{#} | 150 | 150 |

Properties

| | | |
|---|---|---|
| Tensile strength at room | 2.00 | 0.11 |
| temperature, MPa | | |

1. A thermoplastic polyaminoether having the structure of Formula (I): 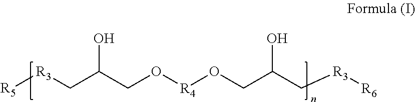
wherein R₃ has the following structure: 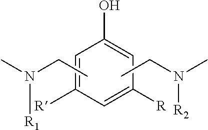
wherein R₁ and R₂ each is independently a monovalent group selected from an aliphatic, cycloaliphatic, aromatic, or polycyclic structure, or mixtures thereof; R is a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅; and R′ is hydroxyl or hydrogen; R₄ is a divalent aromatic moiety; R₅ or R₆ is independently 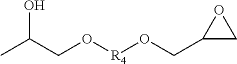
or hydrogen;
and n is an integer from 1 to 400.

2. The thermoplastic polyaminoether of claim 1, wherein R₁ and R₂ each is independently a hydroxyalkyl group.

3. The thermoplastic polyaminoether of claim 1, wherein R₄ has the following structure: 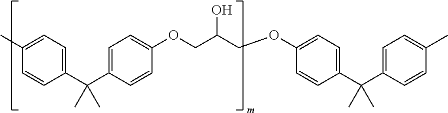
wherein m is an integer from 0 to 5.

4. A process of preparing the thermoplastic polyaminoether of claim 1, comprising:
(i) reacting (a) a monoprimary amine, (b) cashew nutshell liquid, and (c) an aldehyde to form a phenalkamine compound, wherein the molar ratio of cashew nutshell liquid:
aldehyde: monoprimary amine is 1.0:1.0-4.0:1.0-4.0; and
(ii) admixing the phenalkamine compound with a diglycidyl ether, wherein the molar ratio of reactive hydrogens of the phenalkamine compound to oxirane groups of the diglycidyl ether is from 1:0.5 to 1:2.

5. The process of claim 4, wherein the molar ratio of cashew nutshell liquid: aldehyde:monoprimary amine is 1.0:2.0-2.5:2.0-2.5.

6. The process of claim 4, wherein the phenalkamine compound
comprises a compound having the following structure: 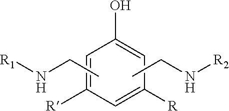
wherein R₁ and R₂ each is independently a monovalent group selected from an aliphatic, cycloaliphatic, aromatic, or polycyclic structure, or mixtures thereof; R is a straight-chain alkyl with 15 carbons containing 0 to 3 C═C bond(s) selected from the group consisting of —C₁₅H₃₁, —C₁₅H₂₉, —C₁₅H₂₇, and —C₁₅H₂₅; and R′ is hydroxyl or hydrogen.

7. The process of claim 4, wherein the monoprimary amine is monethanolamine

8. A multilayer article comprising:
a first layer comprising a thermoplastic polyaminoether, wherein the thermoplastic polyaminoether is a reaction product of a phenalkamine compound having two reactive hydrogen functionalities and a diglycidyl ether, wherein the molar ratio of reactive hydrogens of the phenalkamine compound to oxirane groups of the diglycidyl ether is from 1:0.5 to 1:2; and
a second layer comprising asphalt.

9. The multilayer article of claim 8, wherein the phenalkamine compound is a Mannich reaction product of (a) a monoprimary amine, (b) cashew nutshell liquid, and (c) an aldehyde, wherein the molar ratio of cashew nutshell liquid: aldehyde: monoprimary amine is 1.0:1.0-4.0:1.0-4.0.

10. The multilayer article of claim 8, wherein the phenalkamine compound is a Mannich reaction product of (a) a polyamine having one primary amine group and one secondary amine group, (b) cashew nutshell liquid, and (c) an aldehyde, wherein the molar ratio of cashew nutshell liquid: aldehyde: polyamine is 1.0:0.8-1.8:0.8-1.8.

11. The multilayer article of claim 8, wherein the first layer further comprises a diluent, a catalyst, fillers, aggregates, or mixtures thereof.

12. A process of preparing the multilayer article of claim 8, comprising:
(1) providing a phenalkamine compound having two reactive hydrogen functionalities,
(2) admixing the phenalkamine compound with a diglycidyl ether to form a reaction mixture, wherein the molar ratio of reactive hydrogens of the phenalkamine compound to oxirane groups of the diglycidyl ether is from 1:0.5 to 1:2;
(3) applying the reaction mixture to a substrate to form a first layer comprising a thermoplastic polyaminoether;
(4) separately heating asphalt; and
(5) applying the separately heated asphalt onto the first layer to form a second layer, such that the first layer resides between the substrate and the second layer.

13. The process of claim 12, wherein the phenalkamine compound is prepared by reacting (a) a monoprimary amine or a polyamine having one primary amine group and one secondary amine group, (b) cashew nutshell liquid, and (c) an aldehyde, wherein the molar ratio of cashew nutshell liquid: formaldehyde: monoprimary amine is 1.0:1.0-4.0:1.0-4.0, and the molar ratio of cashew nutshell liquid: aldehyde: polyamine is 1.0:0.8-1.8:0.8-1.8.

14. A thermoplastic asphalt composition comprising:
asphalt, and
a thermoplastic polyaminoether, wherein the thermoplastic polyaminoether is a reaction product of a phenalkamine compound having two reactive hydrogen functionalities, and a diglycidyl ether, wherein the molar ratio of reactive hydrogens of the phenalkamine compound to oxirane groups of the diglycidyl ether is from 1:0.5 to 1:2.

15. The thermoplastic asphalt composition of claim 14, wherein the phenalkamine compound is a Mannich reaction product of (a) a monoprimary amine or a polyamine having one primary amine group and one secondary amine group, (b) cashew nutshell liquid, and (c) an aldehyde, wherein the molar ratio of cashew nutshell liquid: aldehyde: monoprimary amine is 1.0:1.0-4.0:1.0-4.0, and the molar ratio of cashew nutshell liquid: aldehyde: polyamine is 1.0:0.8-1.8:0.8-1.8.

16. A process of preparing the thermoplastic asphalt composition of claim 14, comprising admixing asphalt and a thermoplastic polyaminoether, wherein the thermoplastic polyaminoether is a reaction product of a phenalkamine compound having two reactive hydrogen functionalities and a diglycidyl ether, and wherein the molar ratio of reactive hydrogens of the phenalkamine compound to oxirane groups of the diglycidyl ether is from 1:0.5 to 1:2.
